(19) United States
(12) Patent Application Publication
(10) Pub. No.: US 2024/0096368 A1
(43) Pub. Date: Mar. 21, 2024

(54) MEDIA STRUCTURE CONFIGURED FOR HEAT-ASSISTED MAGNETIC RECORDING AND IMPROVED MEDIA FABRICATION

(71) Applicant: Western Digital Technologies, Inc., San Jose, CA (US)

(72) Inventors: Hua Yuan, San Ramon, CA (US); Hoan Cong Ho, San Jose, CA (US); Paul Christopher Dorsey, Los Altos, CA (US)

(21) Appl. No.: 17/945,747

(22) Filed: Sep. 15, 2022

(51) Int. Cl. G11B 13/08; G11B 5/73

(52) U.S. Cl. CPC G11B 13/08; G11B 5/73917; G11B 2005/0021

(57) ABSTRACT

Various apparatuses, systems, methods, and media are disclosed to provide a heat-assisted magnetic recording (HAMR) medium. A magnetic recording medium includes a substrate, a heat sink layer on the substrate, and an underlayer on the heat sink layer. The underlayer includes an amount of an electrically conductive material between about 20 mole percent (mol %) and about 100 mol %. The magnetic recording medium further includes the plurality of magnetic recording layers on the underlayer. The plurality of magnetic recording layers includes a first magnetic recording layer that comprises FePt—Ag—X, wherein X is an oxide.

### FIELD

The disclosure relates, in some aspects, to magnetic recording media for use with heat-assisted magnetic recording, and more particularly, to a media structure configured for heat-assisted magnetic recording and improved media fabrication.

### INTRODUCTION

Magnetic storage systems, such as a hard disk drive (HDD), are utilized in a wide variety of devices in both stationary and mobile computing environments. Examples of devices that incorporate magnetic storage systems include desktop computers, portable notebook computers, portable hard disk drives, digital versatile disc (DVD) players, high definition television (HDTV) receivers, vehicle control systems, cellular or mobile telephones, television set-top boxes, digital cameras, digital video cameras, video game consoles, network storage systems, and portable media players.

A typical disk drive includes magnetic storage media in the form of one or more flat disks. The disks are generally formed of two main substances, namely, a substrate material that gives it structure and rigidity, and a magnetic media coating that holds the magnetic impulses or moments that represent data in a recording layer within the coating. The typical disk drive also includes a read head and a write head, generally in the form of a magnetic transducer which can sense and/or change the magnetic fields stored on the recording layer of the media.

Energy-assisted magnetic recording (EAMR) systems can increase the areal density of information recorded magnetically on various magnetic media. To achieve higher areal density for magnetic storage, smaller magnetic grain size (e.g., less than 6 nm) media may be used. Heat-assisted magnetic recording (HAMR) is an example of EAMR. In HAMR, high temperatures are applied to the recording media during writing to facilitate recording to small magnetic grains. In some examples, one or more layers of a HAMR medium can be fabricated using radio-frequency (RF) sputtering. However, RF sputtering tends to be slower than direct current (DC) sputtering.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

In one embodiment, a magnetic recording medium includes a substrate, a heat sink layer on the substrate, and an underlayer on the heat sink layer. The underlayer includes an amount of an electrically conductive material between about 20 mole percent (mol %) and about 100 mol %. The magnetic recording medium further includes a plurality of magnetic recording layers on the underlayer. The plurality of magnetic recording layers includes a first magnetic recording layer that comprises FePt—Ag—X, wherein X is an oxide. In one embodiment, the underlayer may have a sufficient electrical conductivity to enable direct current (DC) sputtering of the plurality of magnetic recording layers on the underlayer.

In one embodiment, a data storage device includes the magnetic recording medium; and a write head configured to write data to the magnetic recording medium. The write head includes a near field transducer (NFT).

In one embodiment, a method for manufacturing a magnetic recording medium is provided. The method includes providing a substrate and providing a heat sink layer on the substrate. The method further includes providing an underlayer on the heat sink layer. The underlay includes an amount of an electrically conductive material between about 20 mole percent (mol %) and about 100 mol %. The method further includes providing a plurality of magnetic recording layers on the underlayer. The plurality of magnetic recording layers include a first magnetic recording layer that comprises FePt—Ag—X, wherein X is an oxide. In one embodiment, the underlayer may have a sufficient electrical conductivity to enable DC sputtering of the plurality of magnetic recording layers on the underlayer.

In one embodiment, a magnetic recording medium includes a substrate, a heat sink layer on the substrate, and a plurality of magnetic recording layers on the heat sink layer. The plurality of magnetic recording layers includes a first magnetic recording layer that includes FePt—Ag—MgO.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In similar fashion, while certain implementations may be discussed below as device, system, or method implementations, it should be understood that such implementations can be implemented in various devices, systems, and methods.

### BRIEF DESCRIPTION OF THE DRAWINGS

A more particular description is included below with reference to specific aspects illustrated in the appended drawings. Understanding that these drawings depict only certain aspects of the disclosure and are not therefore to be considered to be limiting of its scope, the disclosure is described and explained with additional specificity and detail through the use of the accompanying drawings, in which:

FIG. 1 is a top schematic view of a disk drive configured for energy-assisted magnetic recording (EAMR) including a slider and an EAMR medium in accordance with one aspect of the disclosure.

FIG. 2 is a side schematic view of the slider and EAMR medium of FIG. 1 in accordance with one aspect of the present.

FIG. 3 is a side schematic view of a first HAMR medium without an RF-sputtered MgO underlayer in accordance with one aspect of the disclosure.

FIG. 4 is a side schematic view of a second HAMR medium without an RF-sputtered MgO underlayer in accordance with one aspect of the disclosure.

FIG. 5 is an illustration of FePt test results of exemplary HAMR media.

FIG. 6 is an illustration of coercivity test results of exemplary HAMR media.

FIG. 7 is a flowchart of a process for fabricating a HAMR medium in accordance with some aspects of the disclosure.

FIG. 8 is a drawing illustrating a sputtering apparatus for fabricating a HAMR medium using DC reactive sputtering.

### DETAILED DESCRIPTION

In the following detailed description, reference is made to the accompanying drawings, which form a part thereof. In addition to the illustrative aspects, aspects, and features described above, further aspects, aspects, and features will become apparent by reference to the drawings and the following detailed description. The description of elements in each figure may refer to elements of proceeding figures. Like numbers may refer to like elements in the figures, including alternate aspects of like elements.

The disclosure relates in some aspects to various apparatuses, systems, and methods for providing magnetic recording media that may be used for, e.g., heat-assisted magnetic recording (HAMR). In some aspects, this disclosure presents examples of HAMR media that have a magnetic layer design that can achieve high areal density and high media anisotropy without using a MgO underlayer (or seed layer) as an orientation control layer. Utilizing MgO as an underlayer can present certain issues. For example, MgO is an electrical insulator having high resistivity. Thus, radio-frequency (RF) sputtering is used for the disposition of a MgO underlayer. However, RF sputtering can be more energy-intensive as compared to direct-current (DC) sputtering, which can be used to deposit, using an applied electrical current during deposition, an electrically conductive material or form a film containing the electrically conductive material. Furthermore, MgO has a low deposition rate (e.g., takes more time to deposit than other materials that can use DC sputtering), resulting in lower total production yields during manufacturing, and during the long MgO deposition process, particle contamination can often occur. These particles can damage or destroy the recording media and can be difficult to remove. Further, MgO is very susceptible to corrosion. For example, a HAMR medium with an RF-sputtered MgO underlayer may have corrosion issues that arise in manufacturing and mass production. In some aspects, a HAMR medium can be fabricated without using an RF sputtering process for the deposition of one or more layers (e.g., the underlayer for the magnetic recording layers) of the HAMR medium.

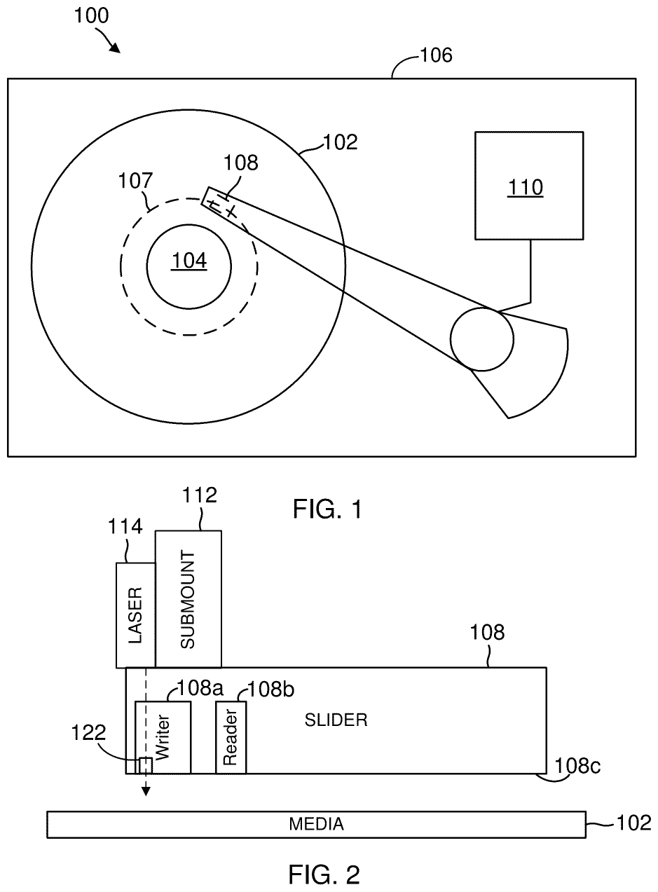

FIG. 1 is a top schematic view of a data storage device 100 (e.g., disk drive or magnetic recording device) configured for energy-assisted magnetic recording (EAMR) comprising a slider 108 and a magnetic recording medium 102 according to one or more aspects of the disclosure. The magnetic recording medium 102 has a magnetic layer design that allows the fabrication of the medium without using radio frequency (RF) sputtering. For simplicity of illustration, the various embodiments of magnetic recording medium will be described in this disclosure as usable for heat-assisted magnetic recording (HAMR), though they are not limited to HAMR or EAMR only and can be used for non-EAMR type magnetic recording. A laser (not visible in FIG. 1 but see 114 in FIG. 2) is positioned with a head/slider 108. Disk drive 100 may include one or more disks/media 102 to store data. Disk/medium 102 resides on a spindle assembly 104 that is mounted to a drive housing 106. Data may be stored along tracks in the magnetic recording layer of disk 102. The reading and writing of data is accomplished with the head 108 (slider) that may have both read and write elements (108a and 108b). The write element 108 a is used to alter the properties of the magnetic recording layer of disk 102 and thereby write information thereto. In one aspect, head 108 may have magneto-resistive (MR) based elements, such as tunnel magneto-resistive (TMR) elements for reading, and a write pole with coils that can be energized for writing. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). It is noted that while an example HAMR system is shown, the various embodiments described may be used in other EAMR or non-EAMR magnetic data recording systems, including perpendicular magnetic recording (PMR) disk drives.

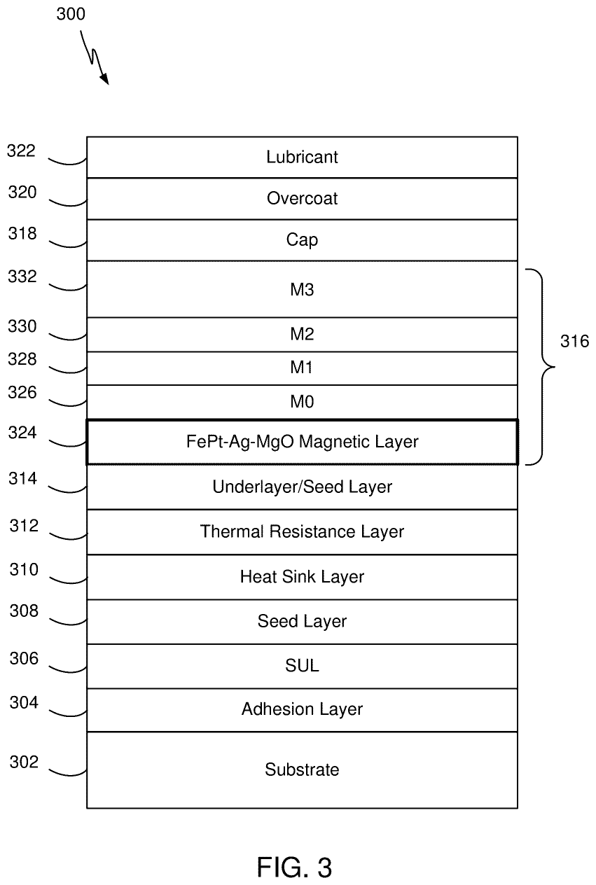

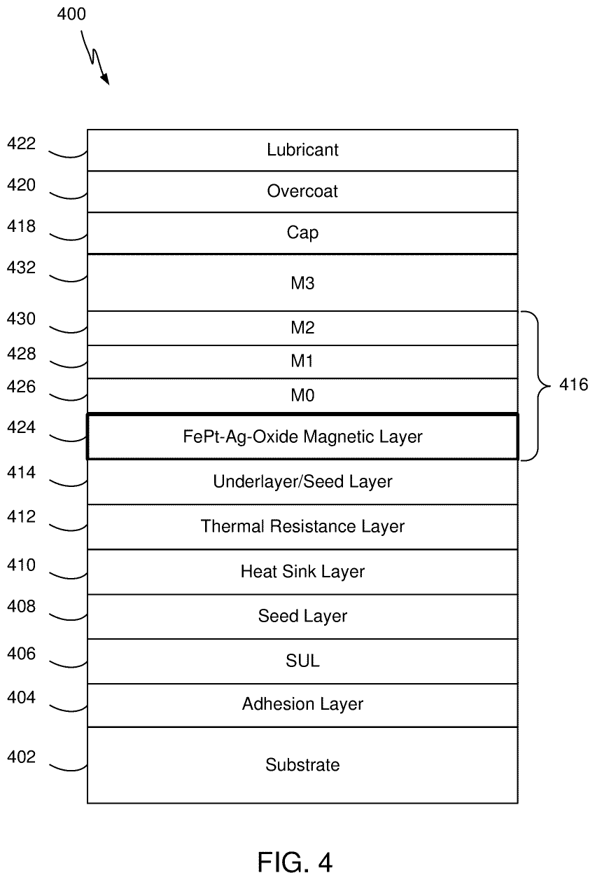

FIG. 2 is a side schematic view of the slider 108 and magnetic recording medium 102 of FIG. 1. The magnetic recording medium 102 may have one or more layers (e.g., media shown in FIGS. 3 and 4) that can be fabricated without using an RF sputtering process in accordance with one or more aspects of the disclosure. The slider 108 may include a sub-mount 112 attached to a top surface of the slider 108. The laser 114 may be attached to the sub-mount 112, and possibly to the slider 108. The slider 108 comprises a write element (e.g., writer) 108a and a read element (e.g., reader) 108b positioned along an air bearing surface (ABS) 108c of the slider for writing information to, and reading information from, respectively, the magnetic recording medium 102.

In operation, the laser 114 is configured to generate and direct light energy to a waveguide (e.g., along the dashed line) in the slider which directs the light to a near field transducer (NFT) 122 near the air bearing surface (e.g., bottom surface) 108c of the slider 108. Upon receiving the light from the laser 114 via the waveguide, the NFT 122 generates localized heat energy that heats a portion of the media 102 within or near the write element 108a, and near the read element 108b. The anticipated recording temperature can be in the range of about 350° C. to 400° C. In the aspect illustrated in FIG. 2, the laser directed light is disposed within the writer 108a and near a trailing edge of the slider. In other aspects, the laser directed light may instead be positioned between the writer 108a and the reader 108b. FIGS. 1 and 2 illustrate a specific example of a HAMR system. In other examples, the magnetic recording medium 102 according to aspects of the disclosure can be used in other suitable HAMR systems (e.g., with other sliders configured for HAMR).

Some aspects of the disclosure provide a HAMR medium and a method of fabricating the HAMR medium without using RF sputtering. In some aspects, the HAMR medium does not have a MgO underlayer. In some aspects, a magnetic recording layer of the HAMR medium can include a FePt-based material. In some embodiments, the FePt-based material can have a chemical composition including a FePt—Ag—X composition, where X is an oxide. In some embodiments, the FePt—Ag—X composition may be a FePt—Ag—MgO or a FePt—Ag—SiO2 composition. In more embodiments, X may be TiO2, ZrO2, WO3, Cr2O3, Al2O3, Fe3O4, NiO, MgOTiO, V2O5, MnO, B2O3, Ta2O5, etc. The oxide may improve FePt nucleation density and grain separation. In some embodiments, the FePt-based material may further include an additive element (e.g., Cu that can reduce ordering temperature and reduce laser power used at the slider). The disclosed HAMR medium can achieve higher areal density and improved magnetic performance (e.g., higher FePt intensity and less dispersion) while having a signal-to-noise ratio (SNR) as compared to a HAMR medium with an RF-sputtered MgO underlayer. In some examples, for a HAMR medium with the FePt—Ag-oxide (e.g., FePt—Ag—MgO or FePt—Ag—SiO2) magnetic recording layer, a HAMR head may need to apply a higher laser current (to write to the medium) than is used for a typical HAMR medium that includes a MgO underlayer.

FIG. 3 is a side schematic view of a first HAMR medium 300 without an RF-sputtered MgO underlayer in accordance with one aspect of the disclosure. The HAMR medium 300 has a stacked structure with a substrate 302 at a bottom/base layer, an adhesion layer 304 on the substrate 302, a soft underlayer (SUL) 306 on the adhesion layer 304, a seed layer 308 on the SUL 306, a heat sink layer 310 on the seed layer 308, a thermal resistance layer 312 on the heat sink layer 310, an underlayer 314 on the thermal resistance layer 312, a magnetic recording layer structure (MRL) 316 on the underlayer 314, a capping layer 318 on the MRL structure 316, and an overcoat layer 320 on the capping layer 318. In some examples, the first HAMR medium 300 can also have a lubricant layer 322 on the overcoat layer 320.

In some aspects, the substrate 302 may be made of one or more materials such as an Al alloy, NiP plated Al, glass, glass ceramic, and/or combinations thereof. In some aspects, the adhesion layer 304 may be made of NiTa and/or other suitable materials known in the art. In some aspects, the SUL 306 may have a high permeability, high saturation magnetization, and low coercivity such as NiFe, CoNbB, FeAlSi, CoFeB, FeTaN, FeTaC, and CoFe, or other suitable materials known in the art. In some aspects, the seed layer 308 may be made of RuAl and/or other suitable materials known in the art.

In some aspects, the heat sink layer 310 may be made of one or more materials such as Ag, Al, Au, Cu, Cr, Mo, Ru, W, CuZr, MoCu, AgPd, CrRu, CrV, CrW, CrMo, CrNd, NiAl, NiTa, combinations thereof, and/or other suitable materials known in the art. In some aspects, the thermal resistance layer 312 can be made of RuAl, RuAlTiO2, and/or other suitable materials known in the art. For example, the thermal resistance layer 312 may have a thickness of about 2 nm. In some aspects, the underlayer 314 may be made of MgOTiO (MTO) and/or other suitable materials known in the art (e.g., besides MgO by itself). The underlayer 314 can function as an underlayer or seed layer to facilitate the formation of the MRL structure 316. In one embodiment, the underlayer 314 may have a composition (e.g., MTO) that provides sufficient electrical conductivity that allows the underlayer 314 and/or MRL structure 316 to be formed using DC sputtering. DC sputtering can be used for non-dielectric or insulative materials. For example, the underlayer 314 may have a resistance (resistivity) less than 40 milliohm-centimeter (mΩ.cm) which corresponds to an electrical conductivity of 2.5 kilo-siemens per meter (kS/m) or more. In one example, the underlayer 314 may contain a suitable amount of electrically conductive material to enable the use of DC sputtering for the fabrication of the underlayer 314 that may or may not contain MgO. In several examples, the underlayer is a combination of materials that can include more than MgO. In some examples, the underlayer is electrically conductive (e.g., 2.5 kS/m or more) and does not consist of MgO (e.g., it may contain MgO plus additional materials). In some aspects, the underlayer 314 may be made of a nitride material (e.g., TiN, VN, CrN, WN, MoN, TiAlN, TaN), a carbide material (e.g., TiC, VC, MoC), a monoxide material (e.g., TiO, VO), an oxynitride or oxycarbide material (e.g., TiON, TiOC, VON, VOC, MoON, CrON), or an alloy of MgO and one of these above materials.

In one example, the underlayer 314 may contain MgO and an electrically conductive material Y, where Y can be the nitride material, carbide material, monoxide material, or oxynitride/oxycarbide material described above. The underlayer 314 can contain between about 20 mole percent (mol %) and about 100 mol % of the material Y. For example, the nitride material may be TiN, VN, CrN, WN, MoN, TiAlN, or TaN. The carbide material may be TiC, VC, or MoC. The monoxide material may be TiO or VO. The oxynitride or oxycarbide material may be TiON, TiOC, VON, VOC, MoON, or CrON. In one example, the underlayer 314 may contain MgOTiO, where TiO acts as the electrically conductive material and has an amount between about 30 mol % and about 100 mol %.

As illustrated, the MRL structure 316 includes five magnetic recording layers (324, 326 (M0), 328 (M1), 330 (M2), 332 (M3)). In some aspects, these sub-layers of the MRL structure 316 may be made of FePt or an alloy selected from FePtX, where X is a material selected from Cu, Ni, and combinations thereof. In some aspects, these sub-layers of the MRL structure 316 may be made of a CoPt alloy. In some examples, the sub-layers of the MRL structure 316 may include one or more of L10 FePt, FePd, CoPt, or MnAl, or possibly a CoPt/CoPd multilayer alloy, each layer having a predetermined thickness, granular structure, small grain size, desired uniformity, high coercivity, high magnetic flux, and good atomic ordering, as would be appropriate for HAMR media. Other additive elements may be added to the aforementioned MRL structure 316 including, e.g., Ag, Au, Cu, or Ni. In other embodiments, there may be a different number of MRLs other than the five MRLs in MRL structure 316.

In some examples, the MRL structure 316 may include magnetic recording sub-layers that are different in their compositions. In one embodiment, the MRL structure 316 may include a magnetic recording layer 324 (e.g., sub-layer) that includes FePt—Ag—MgO. In various aspects, the FePt—Ag—MgO magnetic recording layer 324 may have various compositions of Fe, Pt, Ag, MgO, and an additive. For example, the magnetic recording layer 324 may have between about 15 mole percent (mol %) and about 45 mol % of FePt, between about 0 mol % and about 12 mol % of Ag, between about 15 mol % and about 50 mol % of MgO. In some examples, the additive of the magnetic recording layer 324 may be Cu, C, and/or other suitable materials known in the art. For example, magnetic recording layer 324 may have between about 0% and about 10% of Cu. In one embodiment, the magnetic recording layer 324 has a composition of Fe-26Pt-8Ag-40MgO. In one example, the magnetic recording layer 324 may be part of the magnetic recording layer 326 (MO). In one embodiment, MO may include a FePtAg alloy, M1 may be include a FePtAgCuBN or an FePtAgCuBNC alloy, M2 may include a FePtBNC alloy, and M3 may include a FePtBN(SiO2) alloy.

In some aspects, the capping layer 318 may be made of Co, CoPt, CoFe, or CoPd. In one example, the capping layer 318 can be a multi-layer structure having a layer including Co and Pt/Pd. In some embodiments, the capping layer 318 may be made of specific combinations of materials, for example, Co/Au, Co/Ag, Co/Al, Co/Cu, Co/Ir, Co/Mo, Co/Ni, Co/Os, Co/Ru, Co/Ti, Co/V, Fe/Ag, Fe/Au, Fe/Cu, Fe/Mo, Fe/Pd, Ni/Au, Ni/Cu, Ni/Mo, Ni/Pd, Ni/Re, etc. In additional examples, multilayer layer materials include any combination of Pt and Pd (e.g., alloys), or any of the following elements, alone or in combination: Au, Ag, Al, Cu, Jr, Mo, Ni, Os, Ru, Ti, V, Fe, Re, and the like. In some aspects, the overcoat layer 320 may be made of carbon. In one aspect, the lubricant layer 322 may be made of a polymer-based lubricant.

FIG. 4 is a side schematic view of a second HAMR medium 400 without an RF-sputtered MgO underlayer in accordance with one aspect of the disclosure. The second HAMR medium 400 has a stacked structure similar to the first HAMR medium 300. For example, the HAMR medium 400 has a substrate 402 at a bottom/base layer, an adhesion layer 404 on the substrate 402, an SUL 406 on the adhesion layer 404, a seed layer 408 on the SUL 406, a heat sink layer 410 on the seed layer 408, a thermal resistance layer 412 on the heat sink layer 410, an underlayer 414 on the thermal resistance layer 412, an MRL structure 416 on the underlayer 414, a capping layer 418 on the MRL structure 416, an overcoat layer 420 on the capping layer 418, and a lubricant layer 422 on the overcoat layer 420. The materials used for the various layers of the HAMR medium 400 may be the same as or similar to those described above in relation to the HAMR medium 300. In one embodiment, the underlayer 414 may have a composition (e.g., MTO) that provides sufficient electrical conductivity (e.g., 2.5 kS/m or more) that allows the underlayer 414 and/or MRL 416 to be formed using DC sputtering. In one example, the underlayer 414 may contain an amount of MgO that does not significantly lower the electrical conductivity of the underlayer such that the underlayer 414 can be formed by DC sputtering.

As illustrated, the MRL structure 416 includes five magnetic recording layers (424, 426 (M0), 428 (M1), 430 (M2), and 423 (M3)). In some aspects, these sub-layers of the MRL structure 416 may be made of FePt or an alloy selected from FePtX, where X is a material selected from Cu, Ni, and combinations thereof. In some aspects, these sub-layers of the MRL structure 416 may be made of a CoPt alloy. In some examples, the sub-layers of the MRL structure 416 may include one or more of L10 FePt, FePd, CoPt, or MnAl, or possibly a CoPt/CoPd multilayer alloy, each layer having a predetermined thickness, granular structure, small grain size, desired uniformity, high coercivity, high magnetic flux, and good atomic ordering, as would be appropriate for HAMR media. Other additive elements may be added to the aforementioned MRL structure 416 including, e.g., Ag, Au, Cu, or Ni.

In some examples, the MRL structure 416 may include magnetic recording sub-layers that are different in their compositions. In one embodiment, the MRL structure 416 may include a magnetic recording layer 424 (e.g., sub-layer) that includes FePt—Ag-Oxide. (e.g., FePt—Ag—SiO2). In various aspects, the FePt—Ag-Oxide magnetic layer 424 may have various compositions of Fe, Pt, Ag, oxide (e.g., MgO, SiO2), and an additive such that the magnetic layer 424 has sufficient electrical conductivity to be formed using a DC sputtering process. For example, the magnetic layer 424 may have between about 15 mole percent (mol %) and about 45 mol % of FePt, between about 0 mol % and about 12 mol % of Ag, between about 5 mol % and about 30 mol % of SiO2. In some examples, the additive of the magnetic layer 424 may be Cu, C, and/or other suitable materials known in the art. In one embodiment, the magnetic recording layer 424 has a composition of Fe-34Pt-10.5Ag-21.5SiO2. In one example, the magnetic recording layer 424 may be part of the magnetic recording layer 426 (MO). In one embodiment, MO may include a FePtAg alloy, M1 may include a FePtAgCuBN or FePtAgCuBNC alloy, M2 may include a FePtBNC alloy, and M3 may include a FePtBN(SiO2) alloy.

The terms “above,” “below,” “on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

The HAMR medium 300/400 (without an MgO only underlayer) may have higher areal density and comparable or better SNR (e.g., dcSNR, SNRwrite, SNRread) than a HAMR medium (compare medium) with an RF-sputtered MgO underlayer. In one example, the HAMR medium 300/400 may have greater FePt intensity (i.e., narrower easy axis distribution and magnetic property distribution) than the compare medium.

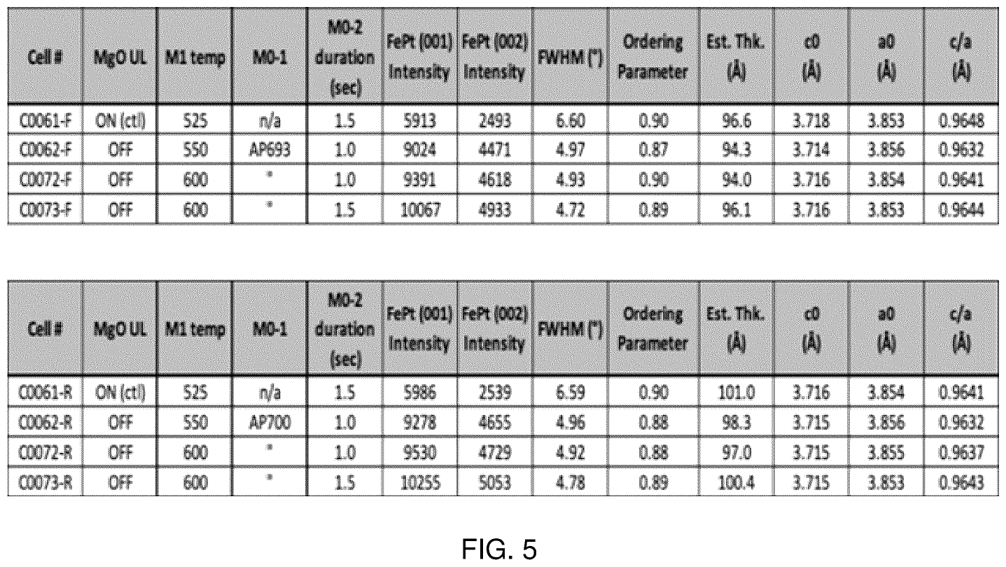

FIG. 5 illustrates exemplary FePt test results of the HAMR medium 300/400 and the compare medium. In this example, the HAMR medium 300/400 (e.g., data corresponding to C0062-F and C0062-R in FIG. 5) has about 100% higher FePt intensity than the compare medium (e.g., data corresponding to C0072-F and C0072-R in FIG. 5).

In one example, the HAMR medium 300/400 may have higher coercivity (Hc) and nucleation field (Hn) than the compare medium.

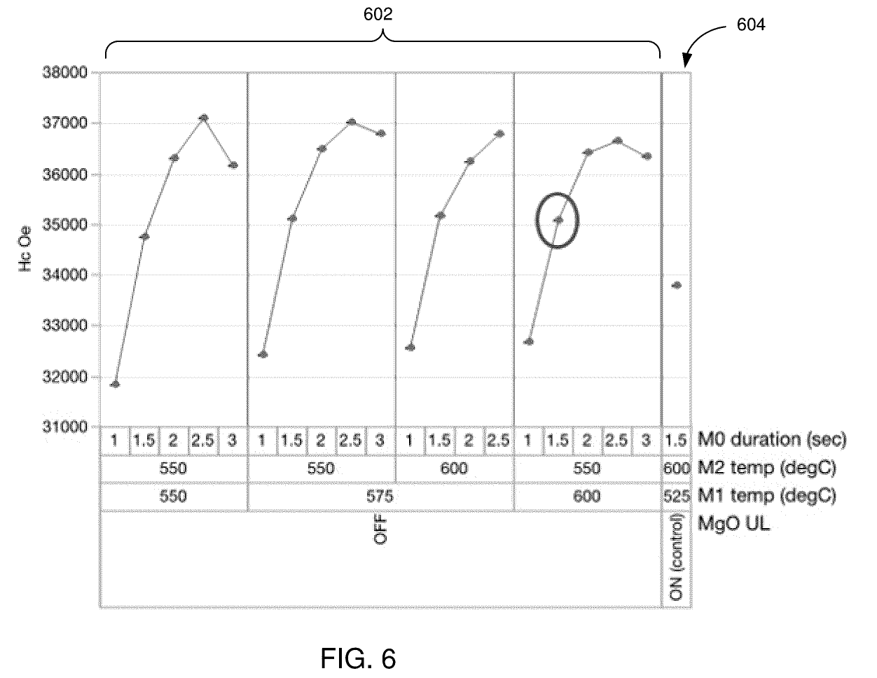

FIG. 6 illustrates coercivity test results of the HAMR medium 300/400 and the compare medium. In this example, the HAMR medium 300/400 may have Hc values 602 higher than the Hc value 604 of the compare medium. In some aspects, the HAMR medium 300/400 may have SNR (e.g., SNRwrinit and SNRrdinit) comparable to the compare medium. In some aspects, the test results of HAMR medium 300/400 show that the HAMR medium 300/400 has significantly less corrosion than the compare medium.

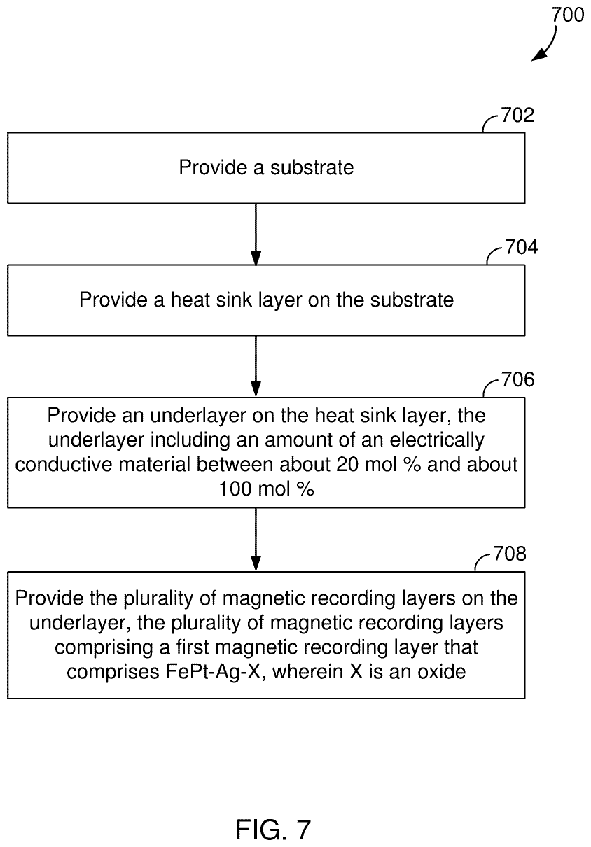

FIG. 7 is a flowchart of a process 700 for fabricating a HAMR medium using DC sputtering in accordance with some aspects of the disclosure. In one aspect, the process 700 can be used or modified to fabricate any of the HAMR media described above in relation to FIGS. 3-6. At 702, the process provides a substrate (e.g., deposits suitable substrate materials). In some aspects, the substrate can be made of one or more materials such as an Al alloy, NiP plated Al, glass, glass ceramic, and/or combinations thereof.

At 704, the process 700 further provides a heat sink layer (e.g., deposits a heat sink layer such as any of heat sink layers 310/410) on the substrate. At 706, the process 700 further provides an underlayer (e.g., deposits an underlayer such as any of underlayers 314/414) on the heatsink layer. The underlayer includes an amount of an electrically conductive material between about 20 mol % and about 100 mol %. Examples of the electrically conductive material include a nitride material (e.g., TiN, VN, CrN, WN, MoN, TiAlN, TaN), a carbide material (e.g., TiC, VC, MoC), a monoxide material (e.g., TiO, VO), an oxynitride or oxycarbide material (e.g., TiON, TiOC, VON, VOC, MOON, CrON), or an alloy of MgO and one of these above materials. The underlayer has sufficient electrical conductivity (e.g., 2.5 kS/m or more) to enable the deposition of the underlayer and subsequent magnetic recording layers using DC sputtering, and without using RF sputtering. For example, the process 700 can deposit one or more magnetic recording layers using DC sputtering on the underlayer. In one aspect, the use of the conductive underlayer avoids the use of RF sputtering for fabrication of the entire HAMR medium.

At 708, the process provides a plurality of magnetic recording layers (e.g., deposits two or more magnetic recording layers) on the underlayer. In some aspects, the process may also provide/deposit an adhesion layer, an SUL, a seed layer, a heat sink layer, and/or a thermal resistance layer on the substrate, before providing/depositing the underlayer and magnetic recording layers. In one example, the plurality of magnetic recording layers may include one or more magnetic recording layers for storing data magnetically. In one embodiment, the plurality of magnetic recording layers may include a first magnetic recording layer that includes FePt—Ag-oxide (e.g., FePt—Ag—MgO or FePt—Ag—SiO2). The first magnetic recording layer may further include an additive (e.g., Cu). The first magnetic recording layer may be directly on the underlayer (e.g., underlayer 314/414).

In one embodiment, the process can form the magnetic recording layers without using RF sputtering. For example, the process can use a DC sputtering process to form one or more FePt—Ag—MgO or FePt—Ag—SiO2 magnetic recording layers. For example, a FePt—Ag—MgO or FePt—Ag—SiO2 target can be reactively sputtered with a reactive gas (N₂) or pure N2 gas to produce the magnetic recording layer containing FePt—Ag—MgO or FePt—Ag—SiO2. In one example, the DC sputtering process can be performed using a reactive gas (e.g., N₂) concentration between about 60 percent and about 100 percent, at a temperature between about 550 degrees C. (° C.) and about 600° C.

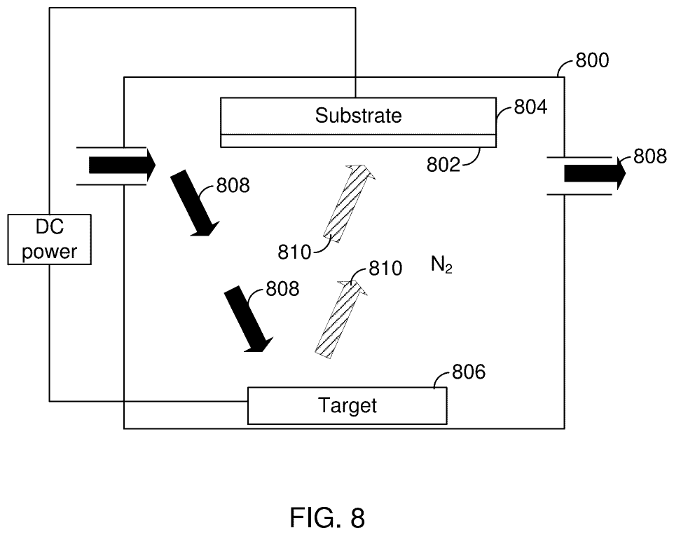

FIG. 8 is a drawing illustrating a reactive sputtering apparatus 800 for fabricating a magnetic recording medium using DC reactive sputtering in accordance with some aspects of the disclosure. In one example, the apparatus 800 may be used to fabricate the HAMR media 300/400 described above using the process 700. The apparatus 800 can be used to deposit a film 802 on a substrate 804. For example, the film 802 may be the FePt—Ag—MgO or FePt—Ag—SiO2 magnetic layer 324/424 described above. To that end, a target 806 of the desired material (e.g., FePt—Ag—MgO or FePt—Ag—SiO2) for forming the film 802 can be used in the apparatus 800. Inside apparatus 800, a reactive gas (e.g., N₂) is introduced into a plasma formed by an inert gas 808 (e.g., argon, xenon, or krypton). The reactive gas is activated by the plasma and chemically reacts with the target material 810 which is subsequently deposited as the film 802 on the substrate 804. During the deposition of the film 802, the substrate 804 and the target 806 can be DC-biased to use DC reactive sputtering to deposit the target. In this example, the target 806 has sufficient electrical conductivity to enable DC reactive sputtering. Therefore, RF sputtering is not used to deposit the film 802. After DC reactive sputtering, a surface portion of the film 802 (e.g., FePt—Ag—MgO or FePt—Ag—SiO2 magnetic layer 324/424 described above) may include an embedded reactive gas (e.g., N2) residue. The reactive gas residue may have a gradient in concentration that decreases inward from a surface of the surface portion.

In one aspect, the process can perform the sequence of actions in a different order. In another aspect, the process can skip one or more of the actions. In other aspects, one or more of the actions are performed simultaneously. In some aspects, additional actions can be performed.

In several aspects, the deposition of such layers can be performed using a variety of deposition sub-processes, including, but not limited to physical vapor deposition (PVD), sputter deposition and ion beam deposition, and chemical vapor deposition (CVD) including plasma-enhanced chemical vapor deposition (PECVD), low pressure chemical vapor deposition (LPCVD) and atomic layer chemical vapor deposition (ALCVD). In other aspects, other suitable deposition techniques known in the art may also be used.

### Additional Aspects

The examples set forth herein are provided to illustrate certain concepts of the disclosure. The apparatuses, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Aspects of the present disclosure have been described above with reference to schematic flowchart diagrams and/or schematic block diagrams of methods, apparatuses, systems, and computer program products according to aspects of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

The subject matter described herein may be implemented in hardware, software, firmware, or any combination thereof. As such, the terms “function,” “module,” and the like as used herein may refer to hardware, which may also include software and/or firmware components, for implementing the feature being described. In one example implementation, the subject matter described herein may be implemented using a computer readable medium having stored thereon computer executable instructions that when executed by a computer (e.g., a processor) control the computer to perform the functionality described herein. Examples of computer-readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding aspects. For instance, an arrow may indicate a waiting or monitoring period of unspecified duration between enumerated steps of the depicted aspect.

The various features and processes described above may be used independently of one another, or may be combined in various ways. All possible combinations and sub-combinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple may be combined in a single block or state. The example tasks or events may be performed in serial, in parallel, or in some other suitable manner. Tasks or events may be added to or removed from the disclosed example aspects. The example systems and components described herein may be configured differently than described. For example, elements may be added to, removed from, or rearranged compared to the disclosed example aspects.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Various components described in this specification may be described as “including” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. The term “about ‘value X’”, or “approximately value X”, as used in the disclosure shall mean within 10 percent of the ‘value X’. For example, a value of about 1 or approximately 1, would mean a value in a range of 0.9-1.1. In one aspect, “about” as used herein may instead mean 5 percent. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range.

While the above descriptions contain many specific aspects of the invention, these should not be construed as limitations on the scope of the invention, but rather as examples of specific aspects thereof. Accordingly, the scope of the invention should be determined not by the aspects illustrated, but by the appended claims and their equivalents. Moreover, reference throughout this specification to “one aspect,” “an aspect,” or similar language means that a particular feature, structure, or characteristic described in connection with the aspect is included in at least one aspect of the present disclosure. Thus, appearances of the phrases “in one aspect,” “in an aspect,” and similar language throughout this specification may, but do not necessarily, all refer to the same aspect, but mean “one or more but not all aspects” unless expressly specified otherwise.

The terminology used herein is for the purpose of describing particular embodiments only and is not intended to be limiting of the embodiments. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” an variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of a, b, or c” or “a, b, c, or any combination thereof” used in the description or the claims means “a or b or c or any combination of these elements.” For example, this terminology may include a, or b, or c, or a and b, or a and c, or a and b and c, or 2a, or 2b, or 2c, or 2a and b, and so on.

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

1. A magnetic recording medium comprising:
a substrate;
a heat sink layer on the substrate; and
an underlayer on the heat sink layer and comprising an amount of an electrically conductive material between 20 mole percent (mol %) and 99 mol %, wherein an electrical conductivity of the underlayer is at least 2.5 kilo-siemens per meter; and
a plurality of magnetic recording layers on the underlayer and comprising a first magnetic recording layer that comprises FePt—Ag—X, wherein X is an oxide.

2. The magnetic recording medium of claim 1, wherein the electrically conductive material comprises MgO and at least one of a nitride material, a carbide material, an oxynitride material, or an oxycarbide material.

3. The magnetic recording medium of claim 1, wherein the underlayer comprises MgOTiO where the electrically conductive material is TiO with an amount between 30 mol % and 99 mol %.

4. (canceled)

5. The magnetic recording medium of claim 1, wherein X comprises at least one of MgO, SiO2, or a combination thereof.

6. The magnetic recording medium of claim 1, wherein X comprises at least one of TiO2, ZrO2, WO3, Cr2O3, Al₂O₃, Fe3O4, NiO, MgOTiO, V2O5, MnO, B2O3, Ta2O5, or a combination thereof.

7. The magnetic recording medium of claim 1, wherein the first magnetic recording layer comprises a surface portion that includes an embedded reactive gas residue formed during sputtering of the first magnetic recording layer.

8. The magnetic recording medium of claim 1, wherein an amount of MgO in the first magnetic recording layer is between about 15 mol % and about 50 mol %.

9. The magnetic recording medium of claim 8, wherein an amount of Pt in the first magnetic recording layer is about 26 mol %, an amount of Ag in the first magnetic recording layer is about 8 mol %, and an amount of MgO in the first magnetic recording layer is about 40 mol %.

10. The magnetic recording medium of claim 1:
wherein X comprises SiO2; and
wherein an amount of SiO2 in the first magnetic recording layer is between about 5 mol % and about 30 mol %.

11. The magnetic recording medium of claim 10, wherein an amount of Pt in the first magnetic recording layer is about 34 mol %, an amount of Ag in the first magnetic recording layer is about 10.5 mol %, and an amount of SiO2 in the first magnetic recording layer is about 21.5 mol %.

12. The magnetic recording medium of claim 1, wherein the first magnetic recording layer further comprises Cu.

13. The magnetic recording medium of claim 1, wherein the first magnetic recording layer is disposed between the substrate and other magnetic recording layers of the plurality of magnetic recording layers.

14. A data storage device comprising:
the magnetic recording medium of claim 1; and
a write head configured to write data to the magnetic recording medium and comprising a near field transducer (NFT).

15. A method for manufacturing a magnetic recording medium, the method comprising:
providing a substrate;
providing a heat sink layer on the substrate;
providing an underlayer on the heat sink layer, the underlayer comprising an amount of an electrically conductive material between 20 mole percent (mol %) and 99 mol %, wherein an electrical conductivity of the underlayer is at least 2.5 kilo-siemens per meter; and
providing a plurality of magnetic recording layers on the underlayer, the plurality of magnetic recording layers comprising a first magnetic recording layer that comprises FePt—Ag—X, wherein X is an oxide.

16. The method of claim 15, wherein the electrically conductive material comprises MgO and at least one of a nitride material, a carbide material, an oxynitride material, or an oxycarbide material.

17. The method of claim 15, wherein the underlayer comprises MgOTiO where the electrically conductive material is TiO with an amount between 30 mol % and 99 mol %.

18. (canceled)

19. The method of claim 15, wherein X comprises at least one of MgO, SiO2, TiO2, ZrO2, W03, Cr2O3, Al2O3, Fe3O4, NiO, MgOTiO, V2O5, MnO, B2O3, Ta2O5, or a combination thereof.

20. The method of claim 15,
wherein X comprises SiO2; and
wherein an amount of SiO2 in the first magnetic recording layer is between about 5 mol % and about 30 mol %.

21. The method of claim 20, wherein an amount of Pt in the first magnetic recording layer is about 34 mol %, an amount of Ag in the first magnetic recording layer is about 10.5 mol %, and an amount of SiO₂ in the first magnetic recording layer is about 21.5 mol %.

22. The method of claim 15, wherein the providing the plurality of magnetic recording layers comprises:
depositing, using direct current (DC) sputtering, the first magnetic recording layer on the underlayer.

23. The method of claim 22, wherein the depositing the first magnetic recording layer comprises:
depositing the first magnetic recording layer using a reactive gas comprising N2.

24. A magnetic recording medium comprising:
a substrate;
a heat sink layer on the substrate;
an underlayer on the heat sink layer and comprising an electrically conductive material, wherein an electrical conductivity of the underlayer is at least 2.5 kilo-siemens per meter; and
a plurality of magnetic recording layers on the underlayer, and comprising a first magnetic recording layer that comprises FePt—Ag—MgO.

25. The magnetic recording medium of claim 24, wherein an amount of MgO in the first magnetic recording layer is between about 15 mole percent (mol %) and about 50 mol %.

26. The magnetic recording medium of claim 24, wherein an amount of Pt in the first magnetic recording layer is about 26 mole percent (mol %), an amount of Ag in the first magnetic recording layer is about 8 mol %, and an amount of MgO in the first magnetic recording layer is about 40 mol %.

27. The magnetic recording medium of claim 24, wherein the underlayer comprises an amount of an electrically conductive material between 20 mole percent (mol %) and 98 mol %.

28. The magnetic recording medium of claim 27, wherein the first magnetic recording layer is directly on the underlayer.
